(19) United States
(12) Patent Application Publication
(10) Pub. No.: US 2008/0215464 A1
(43) Pub. Date: Sep. 4, 2008

(54) Self Service Meal Plans

(75) Inventor: David JOHNSON, Concord, MA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: JSA Technologies, Forth Worth, TX (US)

(21) Appl. No.: 11/948,402

(22) Filed: Nov. 30, 2007

Related U.S. Application Data
(60) Provisional application No. 60/861,710, filed on Nov. 30, 2006.

(51) Int. Cl. G06Q 90/00; G06Q 10/00

(52) U.S. Cl. 705/30; 705/1

(57) ABSTRACT

A system and method for providing definition and management of meal plans and packages for colleges or universities is disclosed. Students may view and flexibly modify selected packages anytime as defined by rules established by the university or college. A student may view the various options for which they may be eligible online and dynamically alter selections as permitted by pre-established criteria. Account balances are automatically reconciled by receiving additional payment or crediting residual balances, if appropriate. In this way, the students can change what type of meal service packages or plans online throughout a school year or semester to suit their changing needs.

### CROSS-REFERENCES TO RELATED APPLICATIONS

This application is a non-provisional, and claims the benefit, of commonly assigned U.S. Provisional Application No. 60/861,710, filed Nov. 30, 2006, entitled “Self Service Meal Plans,” the entirety of which is herein incorporated by reference for all purposes.

### FIELD OF THE INVENTION

The invention is directed to a system and process for providing self service plans, such as for meals in an academic setting or the like.

### RELATED ART

In higher educational settings such as universities or colleges, electronic meal plan systems are frequently implemented to help control and account for which students can eat at particular dining halls on campus during specific times. Managing food service on campuses is a challenge and meal plans are typically the largest revenue generator for campus food service operations. It is not uncommon for a standard meal plan to cost approximately $3,000 per student per year and may be a significant portion of a student's college expenses.

Managing meal plans can be very complex. Campuses frequently allow students to choose between different meal plans to suit their dietary requirements. For example, it is common for most campuses to offer different plans such as plans that offer 5, 10, 15 or 21 meals per week. In most cases, students can only eat meals at campus approved dining halls. However more and more universities and colleges are allowing their students to eat meals under their meal plans at other facilities such as cash facilities and restaurants on and off campus.

Often added complexity arises because students might alter their meal plan options during a semester. For example, some students may choose to upgrade, a number of commuters may choose to purchase meals plans, other students may choose to downgrade, while some students just choose plans more suited to their lifestyle. Also, colleges often give athletes (or other categories of people) access to extended dining hours or alternative dining facilities. Changing a meal plan is complex because it involves several problems including, for example:
1. Campuses have difficulty determining which students are eligible for which plans (not all students are eligible equally for all plans).
2. Campuses have difficulty calculating the price difference between the plans the students currently have and the plan they wish to have.
3. Campuses have difficulty manipulating the electronic accounts to ensure that students have the accounts they are supposed to have and with the right account balances. A single meal plan change can easily require the campus to add, remove, and make deposits between 3 and 6 accounts, for example. This is somewhat analogous to a bank adding a single checking, savings, or mutual fund account on behalf of a customer which can often be time consuming and tedious.
4. Campuses often have difficulty updating or changing accounts on a student by student basis.

From a business perspective, campuses have an additional challenge. Food service is notoriously costly and operates on slim margins. As a result, campuses typically want to increase food service participation by enticing and allowing as many people as possible to participate in meal plan. This generally involves offering meal plans to students living off campus and providing more attractive meal plan packages. For a variety of reasons campuses wish to be flexible in the plans they offer, however this flexibility adds great complexity and cost to the operations. Due to the cost of plans and complexity, small errors can cost the food service department, and their small margins do not leave room for much error.

From an operational point of view, campuses typically have a business imperative to achieve at least:

a) Reducing the costs of managing meal plans; and

b) Increasing the number of people participating in meal plans.

As a comparison, in banking, customers are accustomed to having individual and specific bank accounts. However, meal plans are typically sold in packages whereby the purchase of a single package might include a number of accounts. For example a university might offer the following meal plan packages:

a) Super 21 Plan (at least 4 accounts):
21 meals per week at any dining hall
$250 Campus Cash
$100 Copying Dollars
$50 Off-Campus Spending

b) Standard 21 Plan (2 accounts):
21 meals per week at students dining hall only
$250 Campus Cash

c) Off-Campus Plus (1 account):
$500 Off-Campus Spending

Apparently there is not a product or system known for recording all of these various options. However, numerous people and companies have attempted to address certain aspects of these problems. The following are known approaches that illustrate how various campuses have attempted to deal with these issues.
1. Many campuses have created direct data import feeds with the university enrollment and housing systems. The university or college then manipulates and imports the data into the meal plan management system (typically an ID card management system), and configure the students in bulk. The problem with this approach is that while it works very well during semester transitions, it does not work on an individual by individual basis, and it also does not work well during the course of a semester. Moreover, the data feeds from the enrollment and housing systems are often inaccurate.
2. Some attempts have been made to use the Internet to manage meal plans. However these sites typically involve shopping cart applications that allow students to purchase a plan like a commodity. After a purchase is made, an email is typically sent to the food service office where a human inputs the order into the meal plan system. Some problems usually encountered with this approach are:
   a) Student accounts are not updated immediately.
   b) Student accounts are changed manually which is typically very error prone.
   c) The cost of meal plans on the Internet site may not be accurate because it does not take into account plans the student might already have.
   d) Students cannot remove meal plans.
   e) Students can add plans they already have, leading to duplication.
   f) Students can add plans they are not allowed to have, leading to misuse.
   g) Students can see plans which the campus would prefer they not know about.
3. Students can purchase plans anytime. Frequently only certain meal plans are available at certain times during the campus calendar. However this is usually controlled manually and students cannot see which plans they already have.

### BRIEF SUMMARY OF THE INVENTION

The invention provides a better solution to managing meal plans and accounts than heretofore available by allowing patrons to dynamically subscribe online to packages as defined by a university or school within rules and criteria and to alter subscription to the package by selecting from other available options. The costs are automatically reconciled whenever a change is made to a subscription.

According to one aspect of the invention a method for enrolling a patron in one or more plans at a school may include identifying a set of available meal plan packages. A meal plan package may include one or more meal plans, and each meal plan may include one or more conditions for enrollment. Each of the meal plan packages may include a credit account, a monetary amount and/or a debit account. The method may then identify one or more characteristics of the patron. The method may also remove from the available meal plan packages the packages with conditions that are not met by the characteristics of the patron. The available meal plan packages may be provided to the patron, for example, over the Internet. The patron may then select a package they wish to associate with their account. The school may be a university, a college, a private school, a residential facility, a residential school, a camp, and/or an institution of higher education

The patron may be a student and the patron characteristics may include at least one of whether the student is an athlete, whether the student is a commuter, the graduating class of the student, the housing accommodations of the student, whether the student is married, the student is a recipient of financial aid and/or whether the student is scholarship recipient. Moreover, the patron may be associated with a school and the condition for enrollment may include at least one of the patron must be an athlete, the patron must be a commuter, the patron must be within a specific graduating class, the patron must live on campus, the patron must live within a specific housing complex, the patron must be single, the patron must be married, the patron must be a recipient of a specific scholarship, the patron must be a recipient of financial aid, the patron must have a specific field of study and the patron must work for the school.

According to another aspect of the invention a method for managing a patron's account at a school may identify a first package associated with the patron's account and identify one or more characteristics of the patron. Available second packages may be identified with conditions met by the characteristics of the patron. These available second packages may be provided to the patron and the patron may make a package selection therefrom. The selected package may then be associated with the patrons account. The method may include deleting the plan or plans associated with the first package from the patron's account. The method may also include adding the plan or plans associated with the received package selection to the patron's account. The school may be a university, a college, a private school, a residential facility, a residential school, a camp, and/or an institution of higher education

The method may also request payment for the received package from the patron. The requested payment may be the difference between the cost of the received package selection and the cost of the first package. In one embodiment, the cost of the first package may be the balance of the first account. According to another embodiment, if a refund is disabled on the first package then the requested payment is the cost of the received package selection. The patron's account may be a campus card account. The plans may include a meal plan, monetary amount, credit account and/or a debit account.

According to another aspect of the invention, a system for account management may include a package module, a patron module and an enrollment module. Each module may be part of a one or more processors or computer code. The package module may be configured to maintain one or more packages that include eligibility conditions and at least one of a meal plan and debit account. The patron module may be configured to receive characteristics of a patron, provide a listing of the packages with conditions that are met by the characteristics of the patron to the patron, and/or receive a package selection from the patron. The enrollment module may be configured to associate the patron with the package selected by the patron.

The package module may also maintain the cost for each package, the meal plan allotment, and the debit account allotment. The system may also include a server and the enrollment module communicates with the patron through a webpage. The system may comprise a campus card system and the enrollment module is configured to associate the patrons campus card with the package selected by the patron.

According to another aspect of the invention a self-service meal plan system includes a web server coupled with the Internet. The web server provides a webpage accessible by a student through the Internet. The web server may include memory and at least one processor. The memory is configured to store available packages and any associated conditions, student profiles, and/or student accounts. A package may include at least one of one or more meal plans and one or more debit accounts. The processor may be configured to perform one or more of the following: receive one or more student characteristics, provide a listing of available packages with conditions that are met by the characteristics of the patron on the webpage, receive a package selection from the student through the webpage and associate the package selection with the student account in memory. The student characteristics may be received from the student profile within the memory and/or from the students questions posed through the webpage.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description serve to explain the principles of the invention. No attempt is made to show structural details of the invention in more detail than may be necessary for a fundamental understanding of the invention and the various ways in which it may be practiced.

FIG. 1 is a block diagram showing an exemplary system architecture, according to principles of the invention.

FIG. 2 is a functional flow diagram showing the steps of defining packages and conditions and various inputs for the definitions, according to principles of the invention.

FIG. 3 is a flow diagram showing steps of using the invention, according to principles of the invention.

FIG. 4 is a flow diagram showing steps taken by a user to select a package, according to principles of the invention.

FIGS. 5A-5F are illustrative graphical user interfaces as seen by a user, in view of certain steps of FIGS. 3 and 4.

### DETAILED DESCRIPTION OF THE INVENTION

The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals represent similar parts throughout the several views of the drawings.

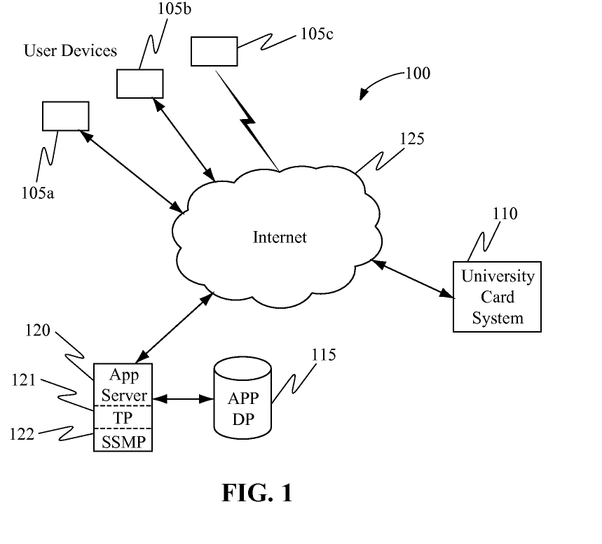

FIG. 1 is a block diagram of an exemplary system architecture, according to principles of the invention, generally denoted by reference numeral 100. This system architecture 100 may include one or more user devices 105a-105c for accessing the functionality of the self service meal plans provided by the invention. The user devices 105a-105c may include a personal computer, cell phones, smart phones, personal digital assistants (PDAs), telephones, or any other user device suitable for interacting via the Internet (or other suitable communications transport medium) with the application server 120, described below. User device 105c accesses the Internet over a wireless connection. The system 100 also includes a card system 110, such as typically found on a university, college or other campus facility. Although embodiments of the invention are described in the university setting, it is understood that embodiments may be used in other settings with similar issues, such as, for example, employee benefit plans, employee meal plans, flexible spending accounts, travel accounts, camp accounts, or a business campus environment. The card system 110 maintains the meal plan and/or debit spending accounts, individual card holder balances of those plans and accounts, and/or other general information related to the card holder. The card system 110 manages transactions for regular use of the meal plans and/or debit accounts including the purchase of meals, spending of debit funds, etc. The card system 110 is in communication with the application server 120 and its resident applications via Internet 125 (or other suitable communication facility). Application server 120 provides for the process control of various aspects of the invention and typically interfaces with a database 115, described more below. The invention includes software applications for implementing the various features, described below, which would execute from the application server 120, or similar type of platform as known to skilled artisans.

On such application provided by the invention typically resident on the application server 120 is the Transaction Processor (TP) 121 which facilitates the actual manipulation (e.g., addition, removal, deposit) of accounts in the school's card system via communication such as the Internet or other suitable connection.

Another such application, denoted as SSMP (Self Service Meal Plan) 122 represents the control logic for implementing certain various steps for documenting a school's meal plan offerings and/or for managing the self-service addition/removal of the meal plans and debit accounts based on the documentation, as described more below.

Certain portions of the invention may also execute at the user devices 105a-105c, such as commonly employed in distributed processing architectures including browser type applications. SSMP 122 also coordinates student account information with the card system 110, as necessary, so that plan and account information relating to individual student cards is current and accurately maintained in operation.

In embodiments, the patron can also access the features provided by the invention by way of a telephone call, with audio prompts to provide to the patron and appropriate selection being input by the patron via the phone keypad or speech response (i.e., using voice recognition technology), for example.

The self-service meal plan scheme provided by the invention provides robust features to meet the specific meal plan management needs such as those found in higher education food service operations. The self service aspects of the invention provide several advantages including, but not limited to:
1. A system for documenting campus meal plan rules (implemented primarily by SSMP), and
2. An electronic system that can implement the documentation (implemented primarily by SSMP) providing a flexible meal plan at least partially controllable by a patron, in view of pre-established rules.

Documentation Overview

The documentation system of the invention provides a convenient and flexible way to accurately record meal plan configurations. For example, the documentation system achieves the following with precision that previous solutions failed to provide, including:
1. A language that eliminates confusion over meal plan terms.
2. A process for recording meal plan rules and eligibility (including removal).
3. A process for recording meal plan packages.
4. A process for recording package prices by specific dates and times.
5. A process for recording the specific amounts that should be available in debit accounts.

Documentation Vocabulary

The documentation process includes a non-limiting vocabulary. The following are representative basic terms (some of which have also been defined elsewhere herein):
Patron: a student, parent, faculty, staff member, or other customer or person with a relationship to a college or university. As used herein, the term student includes the alternatives for patron.
Meal plan: a specific point account (as opposed to a dollar/cents account) resident on a patron's account recognized by an account number on the meal plan management system.
Debit account: a specific account resident on a patron's account that operates using dollars and cents (or any other monetary system).
Package: a collection of meal plans and debit accounts that are sold together as a single commodity.
Rule: a specific set of criteria that determine eligibility and other requirements.

Rules

A step in documenting the meal plan configuration for a campus is to define the rules. The rules dictate the eligibility requirements of individual students or patrons. In practice a rule may include one or more of the following three aspects:
1. A set—which the patrons are eligible.
2. Whether or not the patrons are required to have those packages or not.

Packages

A package is a collection of meal plans and debit accounts. A package may contain an unlimited number of meal plans and debit accounts. Typically, a group of patrons (identified by a rule) are eligible for a given set of packages. Each package usually contains the following information:
1. A list of meal plans.
2. A list of debit plans.
3. A list of other plans, such as specialized counters, plans, privileges, or other card system accounts.
4. An association with a given price list.
5. Whether or not the patron can receive a refund if the package is removed.

Price List

A price list is a list of prices for packages. Each package has an associated price list. The price list typically includes a list of date and time ranges and a price. The price also includes required deposit amounts for debit plans within the package.

Plans

Packages may contain a list of one or more accounts (i.e., plans) that are included in the package. When a patron purchases a package, this is a list of all the accounts (i.e., plans) that will be added to their configuration. When a patron removes a package, these accounts are removed. The configuration for each plan includes the following:
1. The type of plan.
2. A holding account (to be described later).
3. Whether or not a refund of funds on this plan is possible.

Example of Using the Documentation

The following example expands on how the documentation process could be used in practice.
1. A university student visits the food service office to discuss their meal plan options.
2. A clerk in the food service office gathers identity information from the student.
3. The clerk then reviews the meal plan documentation to determine which rules are applicable or available to the student; i.e., which plans does the student qualify.
4. The clerk may then lists the package(s) contained within each rule.
5. The clerk may then determines whether the package(s) are on-sale currently (i.e., available), and if they are on sale, the price is determined for each available package. The clerk finds the current date and time on the price sheet (which may be electronic) and locates what price is listed for each package. If no price or time period is available, the plan is not for sale (i.e., available) and cannot be offered to the student.
6. The clerk also determines if any of the plans in the package are on the price sheet. If so, the clerk may determine what deposit amount is necessary.
7. The clerk may then list for the student all the packages the student is currently eligible for.
8. At this point, a transaction may or may not occur as a number of options are possible:
   a. The student could leave and decline to not purchase a package.
   b. If the student already has a package within a rule, the student could switch to another package within the same rule (example: the student could switch from a Freshman 15 meals plan to a Freshman 21 meals plan).
   c. If the student already has a package within a rule, and the rule is optional, then the student could remove the package.
   d. If the student does not have any packages within a rule, they could purchase one.
9. The clerk may then calculate the price of the transaction.

Calculating Transaction Price Example

The transaction price may be calculated as follows: The transaction price equals the price of the package added minus the price of any packages removed. With, the price of any plan being calculated as follows: Price of plan on price sheet. However, there may be special cases or exceptions that could alter the transaction price, including, for example:
1. If package is being removed (or changed for another), and refunds are disabled, then the price of the package will be ignored and not included.
2. If a plan within a package is being removed, and refunds are enabled, and that plan has a balance, the difference between the deposit amount and the balance will be returned.

An exemplary algorithm is shown below:

```
price(p) = price of package p on price sheet for current date and time
deposit(a) = deposit amount of account a on price sheet for current date
and time refund(x) = whether refunds are enabled on package or account.
balance(a) = current balance on account a
has(p) = whether patron has package p
total = total transaction price
i = generic index variable
pa = package being added (array of plans/accounts)
pr = package being removed (array of plans/accounts)
total = price(pa)
if has(p):
    if refund(pr):
        total −= price(pr)
        foreach plan in pr:
            if refund(plan):
                netbalance = deposit(a) − balance(a)
                total += netbalance
```

Holding Account

Each plan within a package is typically configured with a holding account. This is important for debit plans. When removing a debit plan there may be a remaining balance. This remaining balance can be transferred into a holding account. For example if a student has a given package and within that package there is a plan in which the default balance is $100.00. If the student is not eligible for a refund on the plan, that remaining balance can be transferred into a holding account when the package is removed. This is to keep the accounting accurate. At the same time when a new package is added the added plan may have a holding account. When adding a plan with a holding account the balance of the holding account will be transferred into the account.

Consider a student who is eligible for two different packages. Package A has 21 meals per week and $250 of general spending money. Package B may have 15 meals and $100 in general spending money. The student signed up for Package A when school started. The student then added $50 to their general spending plan.

Student:
21 meals/week
$300 general spending
   Now the student switches to Package B. Switching from Package A to Package B requires removing both the 21 meals/week and the $300 general spending. However, $50 of the general spending is the students to keep because they added it on their own. Simply removing the plan would defraud the student of that amount. At the same time due to technological complexities it is difficult when removing Package A to determine where the $50 should go in the end. To compensate for this the $50 is placed into the holding account.

At this point the campus has two choices. The first option assumes the general spending account on Package A is compatible with the general spending account on Package B. In this case the campus may create a holding account for Package A. When Package A was removed all funds remaining in the general spending plan would be transferred into the holding account. When Package B is added, it will also add in the funds from the holding account.

The second option is when the general spending account is not compatible on Package A with Package B. In this case, the holding account may be different. When Package A is removed the remaining funds may be put into the holding account. However when Package B is added the remaining balances may not be added.

However, if refunds are enabled on the general spending, then the holding account has no effect. Instead, any remaining balance is returned to the patron in the transaction price. If we assume the price of Package A was $1500 and the price of Package B is $1000, the student would be getting a refund of $500. However, if there is a remaining balance in the general spending account and refunds are enabled, instead of being transferred into the holding accounts, the funds would be added to the refund, making the total refund $550.

Embodiments of the invention implements the documentation as described above, and surpasses previous electronic systems. These embodiments may:
1. allow meal plan packages to be purchases online;
2. electronically update the meal plan system quickly;
3. determine which students are eligible for which meal plan packages on an individual by individual basis;
4. ensure that students see only the packages for which they are eligible, so that they cannot see other packages;
5. provide for students to remove packages if they are eligible;
6. accurately calculate the amount students must pay to purchase a package;
7. accurately calculate the amount for refunds;
8. allow students to purchase meal plan packages that have different on-sale periods, for example, a student could purchase winter and spring meal plans during the fall semester;
9. automatically prorate the amount of the meal packages depending upon the time in the semester; and/or
10. allow for configuration for the application to be viewed in Microsoft Excel or other popular desktop applications, so that configuration can be accurately imputed into the system.

The disclosed embodiments of the invention may implement the rules defined by the documentation. The electronic application provides a way by which documentation can be loaded. The electronic application performs many of the steps that a live clerk would typically be expected to perform.

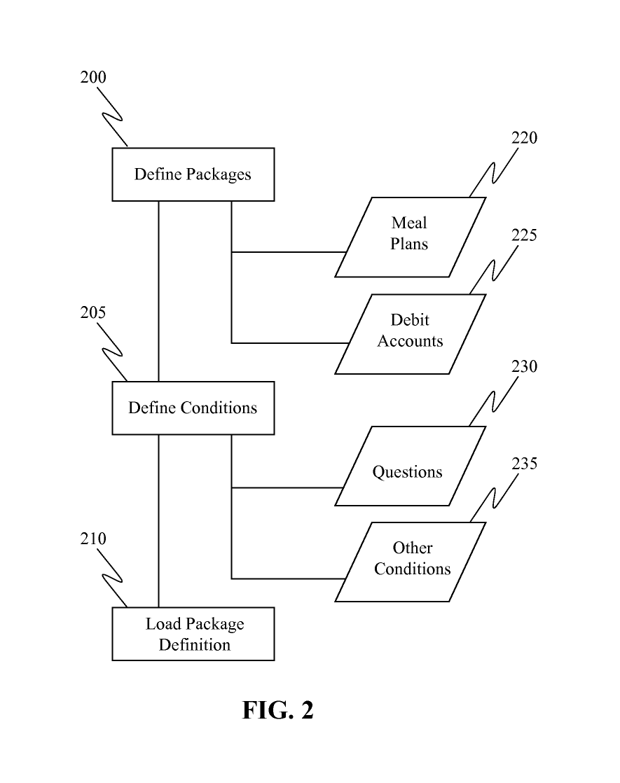

FIG. 2 is a functional flow diagram showing the steps of predefining packages and conditions, according to principles of the invention, starting at step 200. FIG. 2, as well as the other flow diagrams herein, may equally represent a high-level block diagram of components of the invention implementing the steps thereof. The steps of FIG. 2, as well as the other flow diagrams herein, may be implemented on computer program code in combination with the appropriate hardware. This computer program code may be stored on storage media such as a diskette, hard disk, CD-ROM, DVD-ROM or tape, as well as a memory storage device or collection of memory storage devices such as read-only memory (ROM) or random access memory (RAM). Additionally, the computer program code, in parts or in its entirety, can be transferred to a workstation over the Internet or some other type of network, such as by way of a browser, for example.

At step 200, one or more packages are defined which may be based on pre-defined meal plans 220 and debit accounts 225. At step, 205, the conditions of use are established including those questions 230 to be presented to the user (e.g., patrons). Other conditions 235 may include on-off campus patrons, time periods of use, locations of use, satellite facilities, off-campus usage, type of merchant usage, etc. At step 210, the package definitions and conditions are loaded for operational use.

Schools define meal plan packages and the conditions that must be met in order for a user to have access to those packages. The conditions are typically based on at least two factors:
1. Answers to questions the application presents the user when selecting a package; and
2. Information the school has specified and saved to static storage (database) for the purpose of testing whether a user meets the requirements of the condition.

An example of such a condition might be where a student lives. If students live in Smith House, they are eligible for meal plan packages A and B. The school can opt to either ask the user which house they live in or provide the housing assignments of all students so that the information is already available in static storage when the student accesses the self service meal plan system of the invention.

The school can also define the scope of each condition/account pairing. For instance, it might be the case that students living in Smith House are required to take Package A or B. To accomplish this, the condition “lives in Smith House” would be configured with the scope of “Must Have” for Package A and B, as shown in Table 1 below. The SSMP allows them to switch to one of the other plans, but never remove plans such that the student had neither A or B. The same student might meet additional criteria that allow him to add other meal plan packages as well. For instance, a student living in Smith House might also be an athlete which allows them the option to add Package Z. To accomplish this, the additional condition “is an athlete” would be defined with the scope “May Have” for Package Z.

In order to accurately reflect the school's meal plan definitions and requirements, the SSMP is configured with a set of conditions and the meal plan packages available to the user that meets those conditions. The configuration information is stored in static storage (e.g., DB 115) in the form:

TABLE 1

| Condition | Scope | Package |
|---|---|---|
| Lives in Smith House | Must Have | Package A or B |
| Is an athlete | May Have | Package Z |

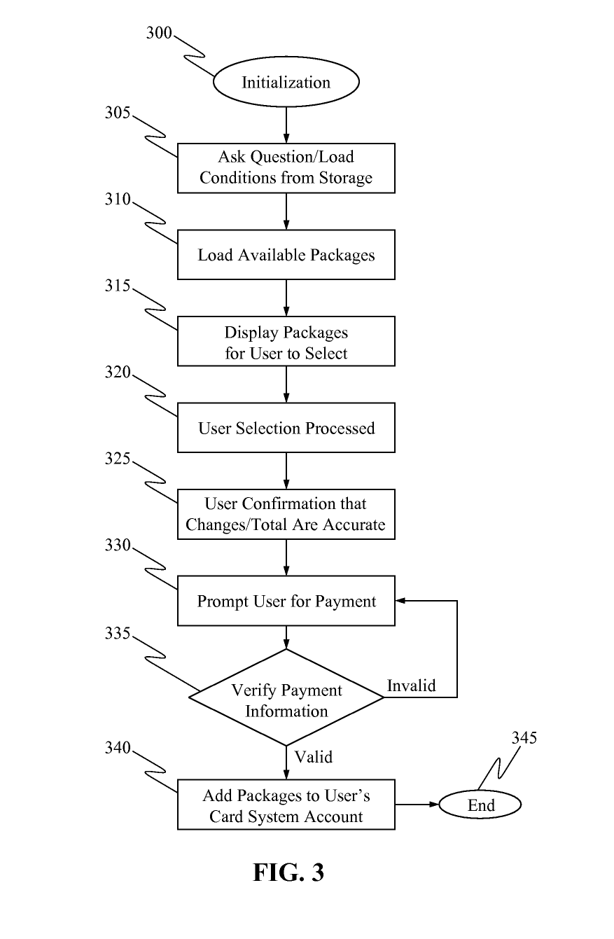

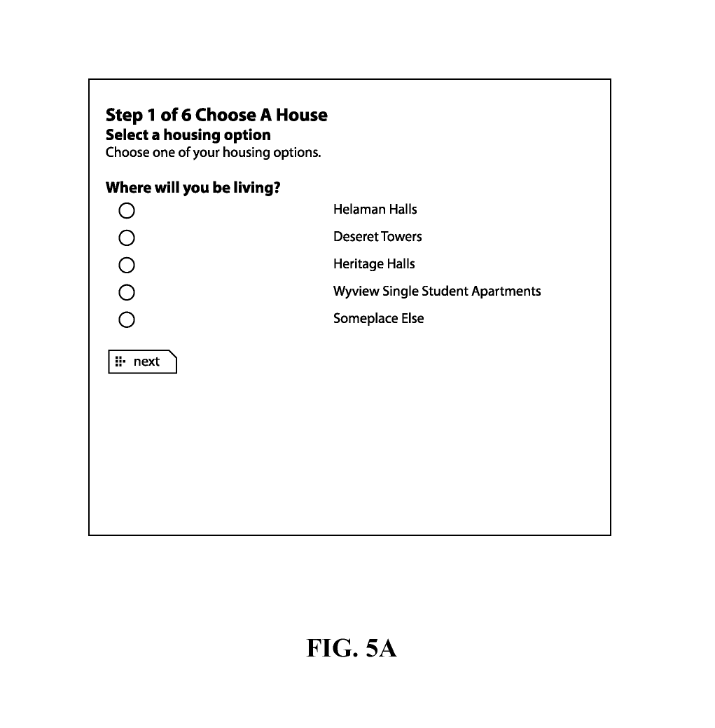

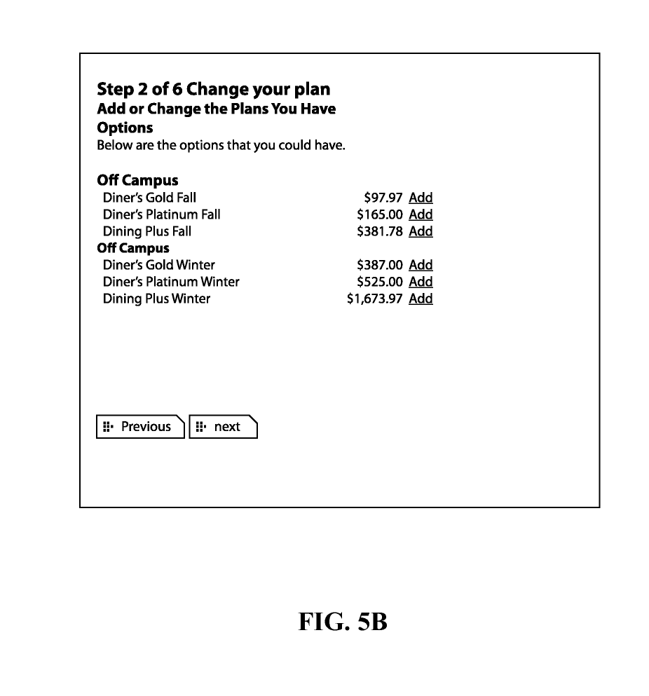

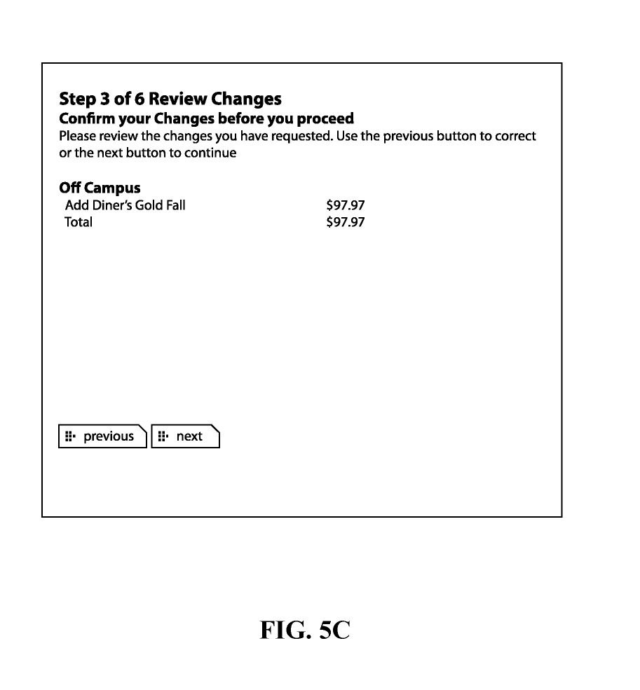

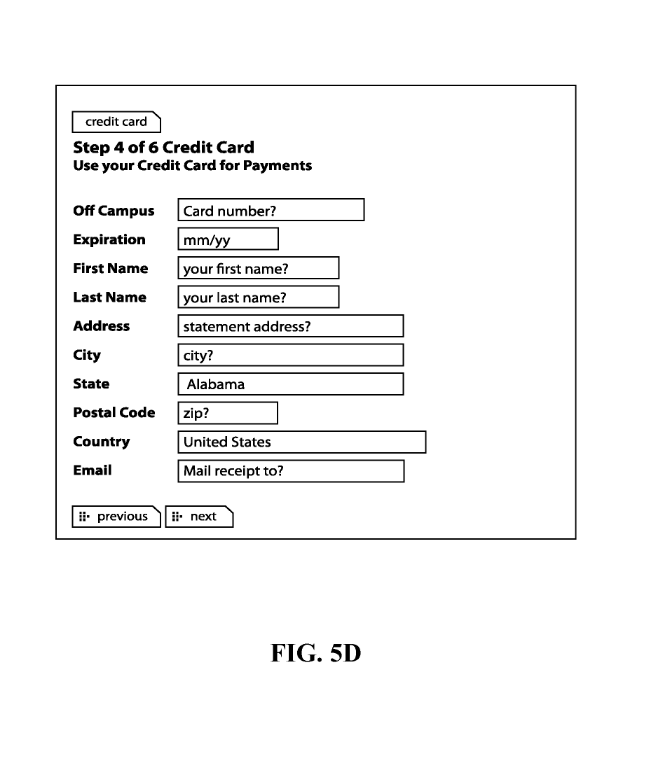

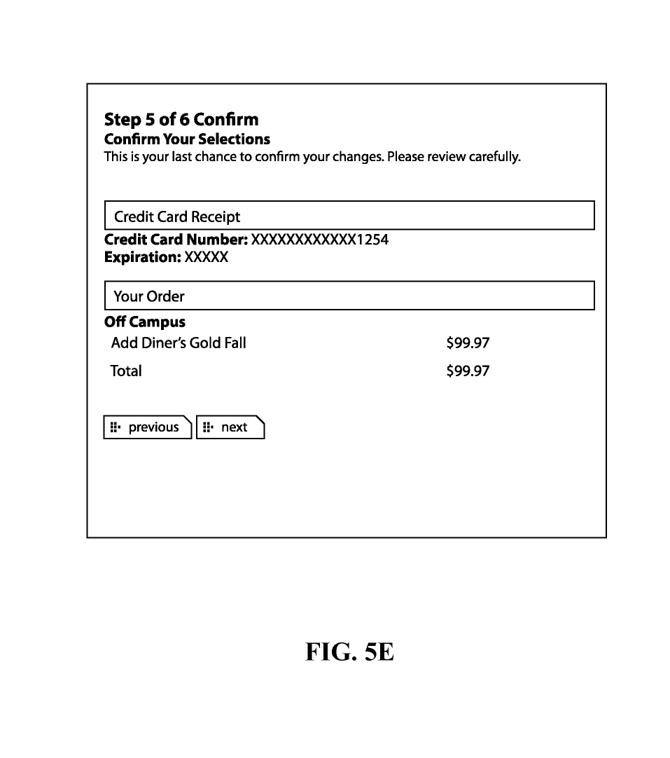

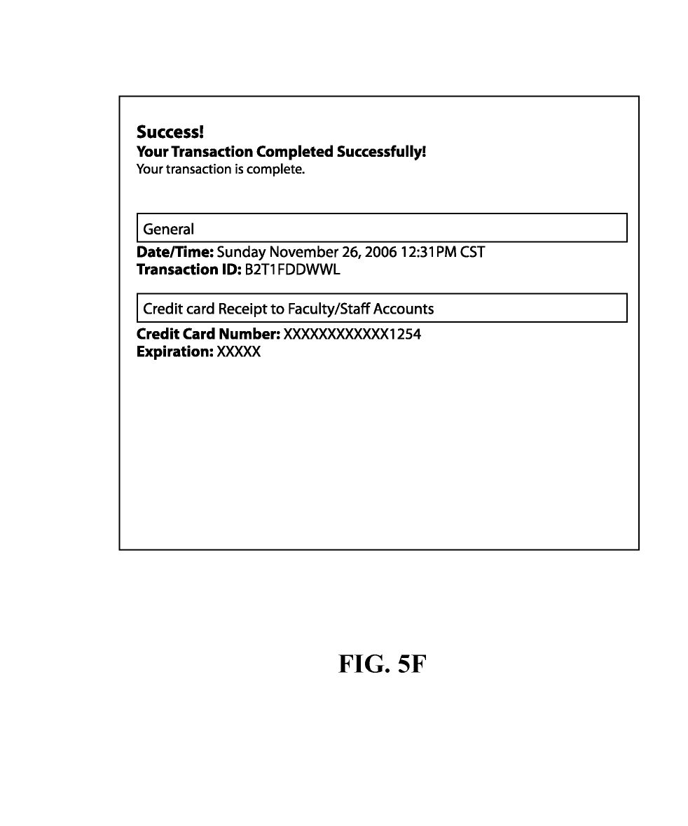

FIG. 3 is a flow diagram showing the steps of using the invention, starting at step 300, where the application is initialized where it loads each condition that the school has defined for determining whether a user meets the criteria set forth in those conditions. It may be helpful to consider FIGS. 5A-5F in relation to the steps of FIG. 3. At step 305, the user's compliance with the conditions is determined by either asking the user a set of predefined questions or by loading the criteria from static storage. At step 310, for each condition that the user meets, the application loads the corresponding packages into the current session as a variable called “$packages,” for example. The following information may be stored in the $packages variable:
“packageid”—The identifier for the current package
sku—The Stock Keeping Unit (sku) for the current package. The sku is used to identify the package in the price tables.
name—The name of the package
pricetable—Where the price table is stored in static storage. The price table represents the prices and deposit amounts available to users based on the current date. This allows schools to prorate costs and deposit amount throughout the course of the year.
price—the price of the package for the current date.
have—does the user have the current package?
enabled—is the package enabled for changes by the user in the application?
scope—is the package required for the user?
refund—is a refund allowed for this package?

At step 315, the package(s) that the user is eligible for are displayed. At step 320, the user's selection is accepted and processed. At step 325, a user confirmation is provided that indicates that the changes and/or total amounts. At step 330, the user is prompted for payment, which is typically a credit card, but may include any form of payment permitted by the school. At step 335, a check is made whether the payment information is valid. If invalid, the user may again be prompted for payment information (perhaps up to a predetermined numbers of invalid attempts). If, however, the check at step 335 indicates that the payment is valid, then at step 340, the selected packages are added to the user's card system account.

There is a high likelihood that users will subsequently log into the application to upgrade, modify, or remove their existing meal plan packages. In order to properly handle this, the application compares the accounts and plans that the requested packages are composed of to the accounts and plans the user currently has. Each package that the user currently has is identified by setting the “have” key in the $packages variable to true.

The application then parses each package the user is eligible for to determine the scope and available actions. For each package, a key is added to the $packages variable indicating the packages scope. Similarly, the application looks at each package, its scope, and whether the user currently has the package to determine which actions the user can take with the package. For packages that a user is eligible for, but they do not currently have the “action” key of the $packages variable is set to “Add.” For packages that a user currently has, the “action” key is set to “Remove.” Additionally, for plans the user currently has for which the scope is set to “Must Have,” the “enabled” key in the $packages variable is set to “False.” Packages that do not have a price defined for the current day are removed from the session and are not considered available to the user. At this point, the exemplary $packages variable for the student living in Smith House might have the following information as shown in Table 2:

TABLE 2

| PackageID | SKU | PriceTable | Price | Have | Enabled | Scope | Refund | Action |
|---|---|---|---|---|---|---|---|---|
| A | SKUA | APRICE | 750 | 1 | 0 | musthave | 1 | Remove |
| B | SKUB | BPRICE | 1000 | 0 | 1 | musthave | 1 | Switch To |
| Z | SKUZ | ZPRICE | 500 | 0 | 1 | mayhave | 1 | Add |

After the application has loaded all packages available to the user and compiled the above information, the package state for the current session is stored in static storage.

The function next loads the debit accounts and meal plans that are associated with each package from static storage. The accounts are stored in the “$accounts” variable and, when all accounts are loaded, the accounts for the session are stored to static storage. The following information is stored in the $accounts variable for each account:
acctid—the account identifier in static storage
num—the account number in the card system
name—the account name
holding—should a transfer of balance from one account to another be required, which account should hold the balance during the transfer
ord—the order of the account within the current package
typeid—the type of the current plan (debit, point, meal, etc)
deposit—amount to deposit to this plan should the package be purchased
display—should the account be displayed as a part of the package in the application
phrase—the phrase used to describe the deposit in the application
displaydeposit—should the deposit to the account be displayed in the application
balance—the balance of the account if the user currently has it
refund—are refunds available for this account

After the application has determined all the conditions the user meets and loads the packages and accounts for each of these conditions, the user is presented with the available meal plan packages and their associated actions (see FIG. 3—step 315, for example). Packages the user has are displayed first in the “Packages you have” section. (The actual headings are all determined by each school's configuration). If the package can be removed, a “Remove” action is displayed next to the package. Packages the user has available to them are displayed under a separate heading (also defined by configuration), with “Add” or “Switch To” actions displayed next to each account. Each of these actions is created by generating a link that loads the application with the “packageid” stored in the $changedpkg variable.

For each condition the school has defined, there is a record in static storage of which packages are affected by the rule. When the user selects an action for a package the application modifies the entry for each package that is affected by the condition that allowed the patron to see that package (see FIG. 3—step 320, for example). Each package within the condition of the selected package is changed such that the enabled flag is false and the “changethis” flag is true. For instance, if a student is living in Smith House who currently has Package A selected the “Switch To” action next to Package B, the resulting package information for the current session would be as shown in Table 3:

TABLE 3

| PackageID | SKU | PriceTable | Price | Have | Enabled | Scope | Refund | Action | Changethis |
|---|---|---|---|---|---|---|---|---|---|
| A | SKUA | APRICE | 750 | 1 | 0 | musthave | 1 | Remove | 1 |
| B | SKUB | BPRICE | 1000 | 0 | 0 | musthave | 1 | Switch To | 1 |
| Z | SKUZ | ZPRICE | 500 | 0 | 1 | mayhave | 1 | Add | 0 |

In order to display the changes made for the user to review, the application fetches from static storage all packages that have “changethis” set to true. For each of these packages, the application displays the action that was taken, the name of the plan, and the price (FIG. 3-Step 125). When the user is adding a single plan, the “Review Changes” page displays the account being added and a total. When the user is instead switching from one plan to another, the “Review Changes” page displays the plan being switched to and its default deposit amount, the plan being removed and its current balance, and a total for the transaction. The student from Smith House switching from Package A to Package B would see output similar to the following example:

| | |
|---|---|
| Switch To Package B | $1000 |
| Account B Deposit | $1000 |
| Remove Package A | $750 |
| Account A Balance | $700 |
| Total Due | $300 |

In the above scenario, the total is calculated with the formula:

price=package add price−balance in removed package

If however, the school had opted not to allow a refund, a holding account would be specified and the current balance (i.e., $700.00) of Package A would be moved to the holding account and then added back to Package B at the end of the transaction. The price in this scenario is simply the purchase price of the Package, but the account for the given package would contain both the default deposit amount and the balance of the prior plan.

If the user agrees that the changes are correct and chooses to proceed to the next step in the transaction, they are presented with a payment page (see FIG. 3—step 330, for example). Across the top of the page is a list of payment options (Credit Card, ACH, Bursar Bill, etc). The school identifies which payment tabs should be presented to the user and which should be the default as a part of their configuration. This information is loaded from static storage and the available payment options are presented to the user. After they select the appropriate tab and fill in the required information, the payment data is verified to insure the information provided is correctly formed for the type of payment option selected (see FIG. 3—step 335, for example).

If the payment information is verified, the application begins to build and complete the transaction (see FIG. 3—step 340, for example). To this end, a connection to the Transaction Processor (TP) 121 is established and the transaction is built step by step. The transaction ID the TP 121 has assigned the current transaction is stored both to the $transid variable and to static storage. The payment information is then inserted as the first step for the transaction. The application then proceeds to build the necessary TP 121 steps to complete the meal plan package changes the user has selected.

The application first identifies whether any accounts need their balance transferred. From static storage, the application loads all accounts for each package with the “changethis” flag set to true and action set to “Remove.” For each account, the account number in the card system, the holding account number, the TP 121 function required to add the account, the TP 121 function required to move funds to the holding account and whether refunds are allowed for the account are loaded. Transfers are determined to be accounts for which refunds are not allowed but whose package is being removed. The application determines whether the user has the holding account. If the user does not have a holding account, the SSMP 122 inserts as the next step the addition of the holding account. The application transfers the current balance of the account to the holding account.

The application next identifies the accounts that need to be added. From static storage, the application loads all accounts for each package with the “changethis” flag set to true and the action set to “Add” or “Switch To.” For each account, the account number in the card system, the holding account number, the deposit amount, the TP 121 function required to add the account, the TP 121 function required to move funds to the holding account, and the TP 121 function required to deposit funds onto the account are loaded. The application inserts a TP 121 step to add each account. If a holding action and account had been specified as a part of an account that is being transferred, the application inserts a transaction to transfer the funds onto the new account from the holding account. If a deposit has been defined for the current account as a part of the meal plan package that was selected, the application next inserts a TP 121 step to add the deposit amount specified in the package configuration to the current account.

The application next identifies accounts to be removed. From static storage, the application loads all accounts for each package with the “changethis” flag set to true and action set to “Remove.” For each account, the account number in the card system, the holding account number, the TP 121 function required to add the account, the TP 121 function required to move funds to the holding account and whether refunds are allowed for the account are loaded. The application then inserts the TP 121 step to remove the account.

After all transfer, addition, and removal steps have been inserted into the TP 121, the application closes out the TP 121 transaction and submits it for processing. All session information is saved to static storage in its final form. The application then loads the processing page which displays information to the user informing them that the transaction is processing. If the transaction takes longer to complete than the school has specified in their configuration settings, the user is informed that the transaction is taking longer than expected and an email will be sent to the email address they provided when the transaction completes. However, if the transaction completes within the timeout period, the application presents the user with a “Success” message and provides them a receipt of the transaction. The Transaction Processor 121 will also send a receipt of the transaction to the user-provided email address once the transaction is completely processed.

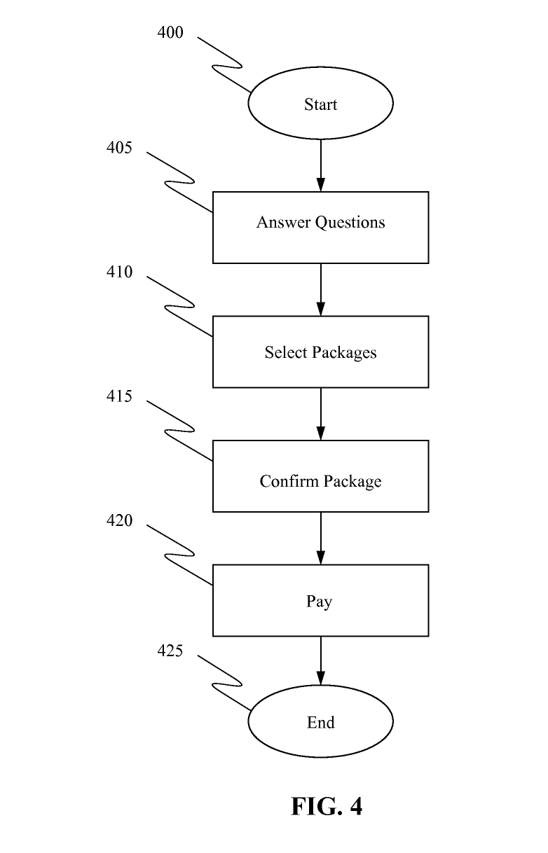

FIG. 4 is a flow diagram showing steps taken by a user to select a package, according to principles of the invention, starting at step 400. The steps of FIG. 4 may be viewed in relation to FIGS. 5A-5F, which show exemplary user interface displays for conveying information a user and for receiving input from a user, according to principles of the invention.

At step 405, in view of FIG. 5A, the user answers questions when prompted by the SSMP 122 in order to establish eligibility for certain available packages. At step 405, the user answers the questions. At step 410, in view of FIG. 5B, the user selects from eligible package(s). At step 415, in view of FIG. 5C, the user is prompted to confirm selected package(s). At step 420, in view of FIG. 5D, the user is prompted to pay for the new package selections, if necessary. It is possible that the new package(s) nets a credit to the user. FIG. 5E illustrates another optional step for confirming the transaction. At step 425, in view of FIG. 5F which shows confirmation information (such as a confirmation number, transaction ID, time stamp and credit card receipt for the transaction), the process ends.

While the invention has been described in terms of exemplary embodiments, those skilled in the art will recognize that the invention can be practiced with modifications in the spirit and scope of the appended claims. These examples given above are merely illustrative and are not meant to be an exhaustive list of all possible designs, embodiments, applications or modifications of the invention. Moreover, while the invention has been described for use with meal plans in an academic setting, it may be applied in similar settings, such as, employee benefit plans, employee meal plans, flexible spending accounts, travel accounts, camp accounts, a business campus environment, etc.

What is claimed is:

1. A method for enrolling a patron in a one or more meal plan packages at a school, the method comprising:
identifying a set of available meal plan packages, wherein the meal plan package comprises one or more meal plans, and each meal plan may include one or more conditions for enrollment;
identifying one or more characteristics of the patron;
removing from the set of available meal plan packages those meal plan packages with conditions that are not met by the characteristics of the patron; and
providing a listing of the set of available meal plan packages to the patron.

2. The method according to claim 1, wherein at least one of the meal plan packages comprises at least one of a meal plan, a debit account, a credit account, or a monetary amount.

3. The method according to claim 1, wherein the patron is a student and the patron characteristics includes at least one of whether the student is an athlete, whether the student is a commuter, the graduating class of the student, the housing accommodations of the student, whether the student is married, whether the student is a recipient of financial aid and whether the student is scholarship recipient.

4. The method according to claim 1, wherein the patron is associated with a school and the conditions for enrollment include at least one of the patron must be an athlete, the patron must be a commuter, the patron must be within a specific graduating class, the patron must live on campus, the patron must live within a specific housing complex, the patron must be single, the patron must be married, the patron must be a recipient of a specific scholarship, the patron must be a recipient of financial aid, the patron must have a specific field of study and the patron must work for the school.

5. The method according to claim 1 further comprising receiving a package selection from the patron and enrolling the patron into the received package selection.

6. The method according to claim 5 further comprising identifying the cost of the package selected by the patron.

7. The method according to claim 6 further comprising:
requesting payment for the selected packages; and
receiving payment for the selected packages.

8. The method according to claim 1, wherein said identifying one or more characteristics of the patron includes receiving answers to questions posed to the patron that identify characteristics of the patron.

9. The method according to claim 1, wherein said identifying one or more characteristics of the patron includes looking up patron information in a database.

10. The method according to claim 1, wherein the school is selected from one of a university, a college, a private school, a residential facility, a residential school, a camp, and an institution of higher education.

11. A method for managing a patron's account at a school, the method comprising:
identifying a first package associated with the patron's account, wherein the first package comprises one or more plans, and each plan may include one or more conditions for enrollment;
identifying one or more characteristics of the patron;
identifying a set of available second packages with conditions met by the characteristics of the patron, wherein the available second packages comprise one or more plans, and each plan may include one or more conditions for enrollment;
providing a listing of the set of available second packages to the patron;
receiving a package selection from the patron; and
associating the received package selection with the patron's account.

12. The method according to claim 11, wherein said associating the received package selection with the patron's account includes:
deleting the plan or plans associated with the first package from the patron's account; and
adding the plan or plans associated with the received package selection to the patron's account.

13. The method according to claim 12 further comprising requesting payment for the received package from the patron, wherein the requested payment is the difference between the cost of the received package selection and the cost of the first package.

14. The method according to claim 13 wherein the cost of the first package is the balance of the first account.

15. The method according to claim 12 further comprising requesting payment for the received package from the patron, wherein a refund is disabled on the first package and the requested payment is the cost of the received package selection.

16. The method according to claim 11, wherein the patron's account is a campus card account.

17. The method according to claim 11, wherein the first and second packages comprise one or more meal plans.

18. A system for account management comprising:
a package module configured to maintain one or more packages, wherein the packages includes eligibility conditions and at least one of a meal plan and a debit account;
a patron module configured to receive characteristics of a patron, provide a listing of the packages with conditions that are met by the characteristics of the patron to the patron, and receive a package selection from the patron; and
an enrollment module configured to associate the patron with the package selected by the patron.

19. The system according to claim 18, wherein said package module maintains the cost for each package, the meal plan allotment, and the debit account allotment.

20. The system according to claim 18, wherein said system further comprises a server and said enrollment module communicates with the patron through a webpage.

21. The system according to claim 18, wherein said system further comprises a campus card system and said enrollment module is configured to associate the patron's campus card with the package selected by the patron.

22. A self-service meal plan system comprising a web server coupled with the Internet, wherein the web server provides a webpage accessible by a student through the Internet, the web server comprising:
memory configured to store available packages and any associated conditions, student profiles, and student accounts, wherein each package includes at least one of one or more meal plans and one or more debit accounts; and
a processor configured to:
receive one or more student characteristics;
provide a listing of available packages with conditions that are met by the characteristics of the patron on the webpage;
receive a package selection from the student through the webpage; and
associating the package selection with the student account in memory.

23. The self-service meal plan system according to claim 22, wherein the student characteristics are received from the student profile within said memory.

24. The self-service meal plan system according to claim 22, wherein the student characteristics are received from the students response to questions through the webpage.
